(19) United States
(12) Patent Application Publication
(10) Pub. No.: US 2005/0258218 A1
(43) Pub. Date: Nov. 24, 2005

(54) Method for joining two metal sheets respectively consisting of an aluminum material and an iron or titanium materials by means of a braze welding joint

(76) Inventors: Christian Schmaranzer, Alkoven (AT); Karl-Heinz Stellnberger, Niederneukirchen (AT); Alois Leitner, Weyregg am Attersee (AT)

Correspondence Address: WILLIAM COLLARD;COLLARD & ROE, P.C., 1077 NORTHERN BOULEVARD, ROSLYN, NY, 11576, US

(21) Appl. No.: 10/530,469

(22) PCT Filed: Oct. 6, 2003
(86) PCT No.: PCT/AT03/00298

§ 371 Date: Apr. 6, 2005

(30) Foreign Application Priority Data
Oct. 7, 2002 (AT) A 1514/2002
May 19, 2003 (AT) A 773/2003

(51) Int. Cl. B23K 35/24

(52) U.S. Cl. 228/262.5

(57) ABSTRACT

A method is described for joining two sheets (1, 2) of aluminum material on the one hand and iron or titanium material on the other hand by a welding-soldering joint by using a filler, with the iron or titanium material being provided at least in the joining region with a coating preferably on the basis of zinc or aluminum before the filler is applied by forming a weld seam (4) under melting. In order to provide advantageous joining conditions it is proposed that the two sheets (1, 2) are joined in the form of a butt-joint, with the filler on the basis of aluminum being applied for the formation of the weld seam (4) on both sides of the sheet in a region bridging the joint onto the sheet (1) made of iron or titanium material in a width (b) corresponding to at least three times the thickness (d) of said sheet (1).

### FIELD OF THE INVENTION

The invention relates to a method for joining two sheets of aluminum material on the one hand and iron or titanium material on the other hand by a welding-soldering joint by using a filler, with the iron or titanium material being at least in the joining region provided with a coating preferably on the basis of zinc or aluminum before the filler is applied by forming a weld seam under melting.

### DESCRIPTION OF THE PRIOR ART

During the thermal joining of an aluminum material with a steel material, the aluminum material is molten in the joining region, so that the molten aluminum wets the steel material and leads to an adhesively joined connection. In the transitional region between the materials, brittle intermetallic phases are formed however which relevantly co-determine the resilience of the joint. In order keep the thickness of these intermetallic phase seams small, the diffusion conditions in the transitional region of the materials need to be influenced accordingly such that the melting phase is limited to a short time interval by maintaining relatively high heating and cooling rates. This is achieved advantageously when the sheets to be joined are arranged in an overlapping joint and are heated in the overlapping region from the steel material with a defocused laser beam. The overlapping connection joints lead to a locally higher stiffness for a later forming of the joined sheets. Moreover, one must expect a high inclination towards corrosion in the region of the overlapping joint as a result of the electrochemical difference of potential between steel and aluminum material since a complete closure of the separating line in the overlapping region cannot be expected, even if a filler on the basis of aluminum is added during the melting of the aluminum material. Similar difficulties arise during the joining of sheets made of an aluminum material on the one hand and a titanium material on the other hand because a brittle intermetallic phase seam also occurs for this combination of materials.

In order to substantially prevent the occurrence of brittle intermetallic phases in the region of a weld joint between a steel and aluminum material, it is finally known (DE 10 017 453 A1) to provide the steel material at least in the joining region with a coating on the basis of zinc or aluminum before a filler on the basis of zinc is applied between the steel or aluminum material under melting for the formation of a weld joint. This filler enters into a melt-metallurgical welded joint with the aluminum material and is used as a solder for the connection with the steel material, with the filler not coming into molten contact with the steel material, but exclusively with the coating material, so that intermetallic phases can be suppressed substantially as a result of the chosen filler on the basis of zinc. The disadvantageous aspect in this known joining method is that the joining seam formed by the filler can only be provided in the interstitial region between two diverging surface regions of the materials to be joined and requires a filler on the basis of zinc which is clearly different from the aluminum material. If a filler on the basis of aluminum is used (U.S. Pat. No. 3,202,793 A), then it is possible to prevent this disadvantage, but the strength of this welding-soldering joint is insufficient, even if the iron sheet is provide in the joining region with breakthroughs for improving the strength in order to obtain an improved bonding of this filler with the iron sheet through the filler passing through said breakthroughs.

### SUMMARY OF THE INVENTION

The invention is thus based on the object of providing a method for joining two butt-jointed sheets of an iron or titanium material on the one hand and an aluminum material on the other hand, allowing a durable connection meeting all loading requirements between the sheets of different materials without having to use a filler based on aluminum.

Based on a method of the kind mentioned above, the invention achieves this object in such a way that the two sheets are joined in the form of a butt-joint, with the filler on the basis of aluminum being applied for the formation of the weld seam on both sides of the sheet in a region bridging the joint onto the sheet made of the iron or titanium material in a width corresponding to at least three times the thickness of said sheet.

Since as a result of this measure the filler on the basis of aluminum bridges the joint between the sheets on both sides of the sheets, the weld seam formed by said filler covers a boundary region of the iron or titanium material on both sides of the sheet, which not only enlarges the joining surface but also represents a relevant precondition that no crevice corrosion can occur in the region of the joint. Since also the electrochemical difference of potential between the coating of the iron or titanium material and the filler material is clearly reduced in comparison with the difference of potential between the iron or titanium material and the aluminum material, the likelihood of contact corrosion can be reduced to a decisive extent. The likelihood of the formation of brittle intermetallic phases is reduced as a result of the coating of the iron or titanium material in the region of the joint. For this purpose, the filler on the basis of aluminum can be alloyed in the known manner for increasing the strength, thus leading to high resilience for the joint in accordance with the invention, especially since the supporting cross section is increased through the weld seam bridging the joint between the two sheets.

To ensure that a strength can be ensured via the weld seam which meets all requirements, the weld seam formed by the filler must grasp on both sides to a respective extent beyond the edge of the sheet made of the iron or titanium material. If the filler is applied to the sheet made of iron or titanium material in a width corresponding to at least three times the thickness of said sheet, then it is possible to maintain the strength values in the region of the seam as are obtained in the adjacent sheet regions.

In order to achieve a gradual take-up of load between the different materials by avoiding excessive tension peaks, the sheet made of iron or titanium material can be provided advantageously in the region of the joint with a chamfer on at least one side of the sheet, so that the supporting cross section of the iron or titanium material decreases towards the aluminum material, while the supporting cross section of the aluminum material is increased accordingly. This chamfer needs to be covered with a coating on the basis of zinc, tin or aluminum like the remaining joining region in order to ensure the material bonding between the iron or titanium material and the filler. Although the weld seam by the filler which bridges the region of the joint between the sheets leads to a crowning of the joint region, this crowning by the weld seam on both sides does not play any decisive role for the later forming of the butt-jointed sheets. The weld seam may under certain circumstances also be flatted by plastic deformation. It is also possible to join the two sheets in such a way that their surfaces lie on one side in a common plane and, after the application of the weld seam in the region of the joint, to bend them away from the same by the respective thickness of the excess portion of the seam over the common surface. This measure leads on one side to a surface of the joined sheets which extends continuously over the weld seam.

As a result of the coverage of the boundary region of the iron or titanium material by the weld seam, any potential crevice corrosion is limited to the transitional region between the longitudinal edge of the weld seam on the side of the iron or titanium material and its coating. If the coating material comprises a limited solubility in aluminum, it may occur that the coating material builds up in the filler on aluminum basis in the transitional region and forms a starting point for a corrosive attack. In order to prevent even this very low danger in a simple manner, the weld seam between the two sheets as formed by the filler can be covered by a corrosion protection layer on at least one side of the sheets in the transitional region to the coated iron or titanium material, especially a coat of lacquer.

Sheet blanks made of an iron or titanium material on the one hand and of an aluminum material on the other hand which are joined with the help of the weld seam in accordance with the invention can also be formed in the region of the weld seams without overloading the weld seam, which allows the simple production of subjects from such sheet blanks because the sheet blanks are joined prior to cold forming and are formed into the subject together by cold forming. The precondition is that the required forces can be transmitted via the welding-soldering joint in order to allow plastifying the joined sheet blanks and thus forming them. This is achieved in such a way that the weld seam is applied to the side of the sheet blank made of iron or titanium material in a width which corresponds to at least three times the thickness of said sheet blank. This condition that can be fulfilled very easily ensures that the normal stress critical for the resilience of the weld seam remains in a permitted range even in the case of a plastic forming of the joined sheet blanks in the region of the soldering zone between the filler on the basis of aluminum and the sheet blank made of iron or titanium material because the joining surface is enlarged accordingly.

Although the weld seam of the filler material which bridges the joint region between the sheet blanks leads to a crowning of the joint region, this crowning does not play a decisive role for the later forming of the butt-jointed sheets as a result of the weld seam on both sides, because the crowning of the seam can be taken into account by respective recesses in the forming tools. In order to reduce the crowning of the seam, the weld seam formed by the filler can be flattened between the two sheet blanks prior to the common cold forming of the joined sheet blanks.

### BRIEF DESCRIPTION OF THE DRAWINGS

The method in accordance with the invention is explained in closer detail by reference to the drawings, wherein:

FIG. 1 shows a top view of two sheet blanks made of a steel material on the one hand and an aluminum material on the other hand, which are joined according to the method in accordance with the invention;

FIG. 2 shows a sectional view through the weld seam between the butt-jointed sheet blanks in a sectional view along line II-II of FIG. 1 on an enlarged scale;

FIG. 3 shows an illustration according to FIG. 2 with a weld seam flattened by plastic deformation;

FIG. 4 also shows an illustration according to FIG. 2 of a constructional variant of a weld seam produced in accordance with the invention;

FIG. 5 shows a weld seam according to FIG. 4, but after an additional forming, and

FIG. 6 shows a simplified diagram on an enlarged scale of the subject produced by cold forming from the joined sheet blanks according to FIG. 1.

### DESCRIPTION OF THE PREFERRED EMBODIMENT

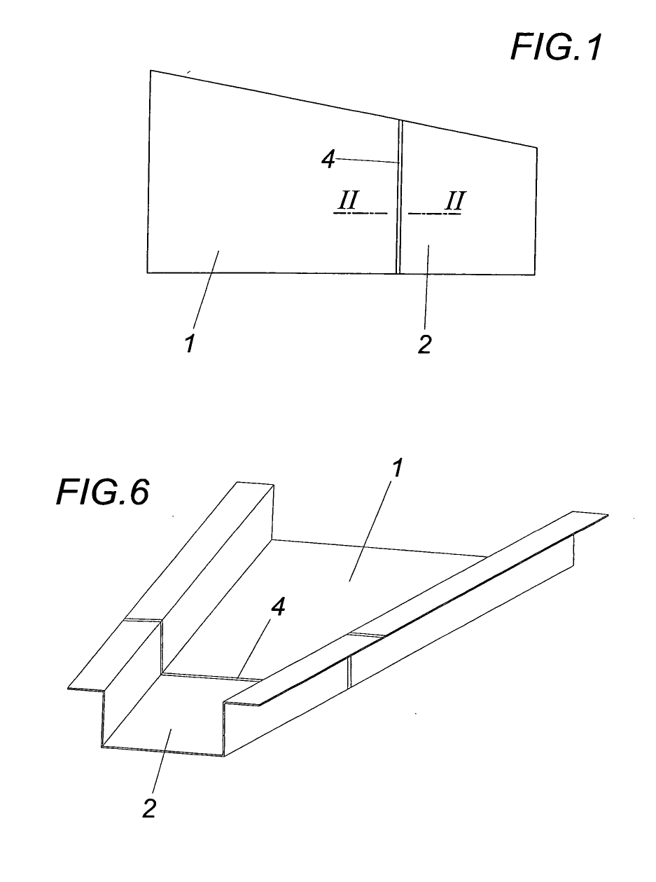

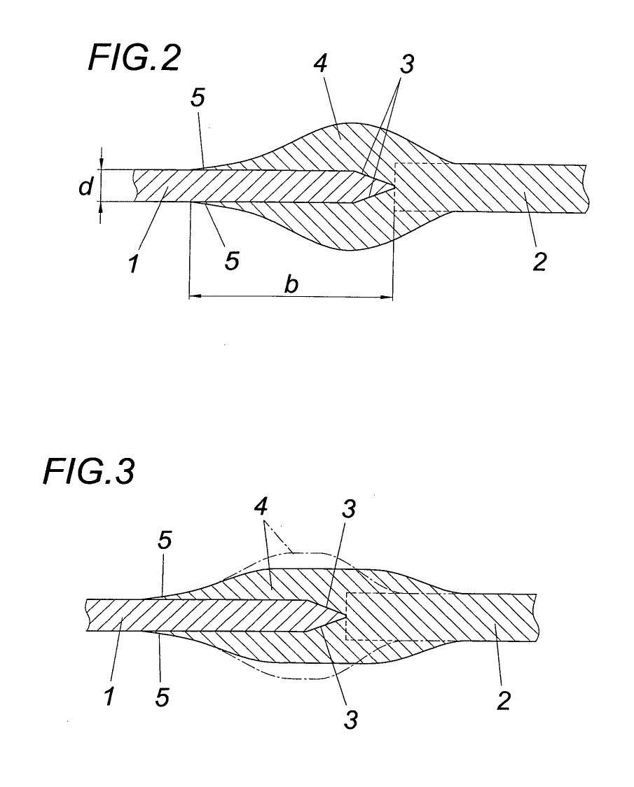

Plane sheet blanks 1 and 2 as are indicated in FIG. 1 are used for producing the subject as shown in FIG. 6, e.g. a profile support, from a cold-formed sheet blank 1 made of iron material and an also cold-formed sheet blank 2 made of an aluminum material. Said sheet blanks 1 and 2 are butt-joined. For this purpose the sheet blank 1 made of iron material is provided in the region of the edge forming the butt-joint with chamfers 3 on both sides, as is shown in FIG. 2. These chamfers 3 are provided with a coating preferably on the basis of zinc, like the other surfaces in the joining region. After joining the sheet blanks 1 and 2 to be joined, a filler on the basis of aluminum is applied to both sides of the blanks 1 and 2 in the joint region and molten with the help of an arc. A melt-metallurgical weld joint is obtained between the aluminum material of the sheet blank 2 and the filler on the basis of aluminum which forms the weld joint. This weld joint obtained by melting the aluminum material is indicated by a uniform hatching of the sheet blank 2 and the weld seam 4, with the original edge of the sheet blank 2 being indicated by the broken line. The molten filler represents a solder for bonding with the sheet blank 1 made of iron material, which solder is not only applied in the immediate joint region of the two sheet blanks 1 and 2, but also bridges the joint and covers on both sides the edge of the sheet blank 1 made of iron material. The filler forming the solder is applied to a coverage region which comprises a width b corresponding to at least three times the thickness d. As a result of the thus formed increase in the bonding length, the normal stress in the region of the soldering zone which is co-decisive for the resilience of the weld seam is limited to a permissible amount on the one hand and losses of strength in the joint which are caused by corrosion can be kept respectively low by corrosion paths below the corrosion-induced losses of strength of the weaker basic material of the joined sheet blanks 1, 2, so that the joining region shows strength values over the entire life of the subject which correspond at least to the strength values of the weaker of the two sheet blanks 1, 2.

After producing the weld seam 4, the joined sheet blanks 1 and 2 can be provided with an anti-corrosive protection layer. For this purpose, the sheet blanks 1, 2 can be subjected in the conventional manner to dip-coating. The transitional region 5 between the weld seam 4 and the coated sheet blank 1 made of the steel material is advantageously covered by the lacquer layer so that no corrosion can occur in this transitional region 5 which over time would propagate towards the direct region of the joint.

Since for the purpose of adjusting the inherent strengths the thickness of the sheet blank made of aluminum is chosen larger than the thickness d of the sheet blank 1 made of steel material, the weld seam 4 can lead to a respective crowning of the weld point between the two sheet blanks 1 and 2. In order to limit such crowning without any endangerment to the joint between the two sheet blanks 1 and 2, the weld seam 4 which is indicated in its original form by a dot-dash line according to FIG. 3 can be flattened by plastic deformation, as is shown by the unbroken line.

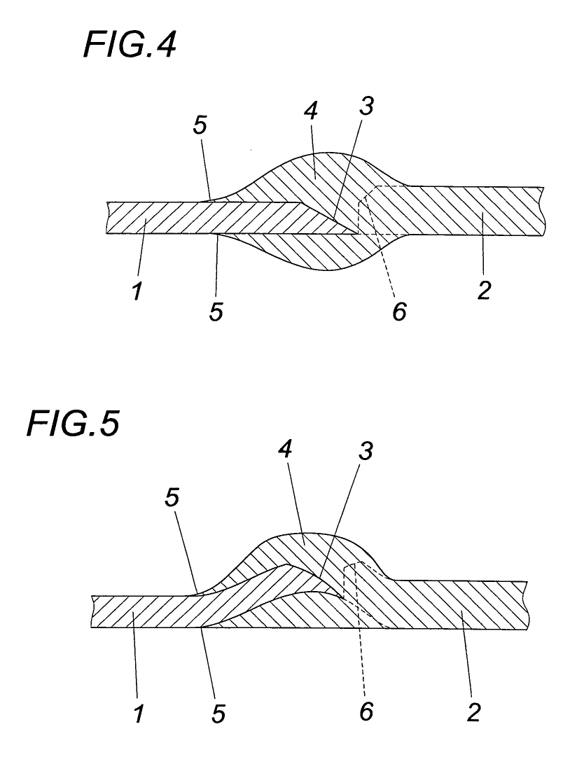

The symmetrical arrangement of the sheet blanks 1 and 2 as shown in FIGS. 2 and 3 is not required in any way for the production of a weld seam 4 in accordance with the invention. The surfaces of the sheet blanks 1 and 2 could be situated on one side in a common plane, as is shown in FIG. 4. Such a configuration leads to a differently shaped weld seam 4 without changing the fundamental conditions. Since it makes little sense in the embodiment according to FIG. 4 to also provide the edge of the sheet blank 1 with a chamfer on the surface side flush with the sheet blank 2, only the opposite side of the sheet blank is provided with a chamfer 3. In this case it is also recommended to provide a chamfering 6 of the sheet blank 2 made of the aluminum material in order to provide an advantageous formation of the seam. In addition, the region of the seam can also be deformed in accordance with FIG. 5 in such a way that on the one side of the sheet a common surface is obtained which extends continuously over the weld seam 4. This is achieved when the sheet blanks are bent off in the region of the seam by the respective thickness of the projecting portion of the seam over the common surface, as is shown in FIG. 5.

After the joining, the sheet blanks 1 and 2 are jointly formed by welding-soldering joint into the subject according to FIG. 6, e.g. by bending or deep drawing. The forces required for plastic deformation of the sheet blanks 1 and 2 can be easily transmitted in these cold forming methods via the weld seam 4. The crowning by the weld seam 4 can be taken into account during plastic forming of the joined sheet blanks 1, 2 which are plane at first by a respective configuration of the tools, e.g. by recesses in the region of the weld seam 4. The crowning can also be flatted by plastic deformation according to FIG. 3.

It is understood that the invention is not limited to the illustrated embodiment. A blank made of a titanium material can be used instead of a sheet blank 1 made of an iron material, which titanium blank can be joined in a comparable manner by welding-soldering in a corrosion-proof manner with an aluminum material by way of a filler on the basis of aluminum as long as the parameters in accordance with the invention are observed.

1. A method for joining two sheets of aluminum material on the one hand and iron or titanium material on the other hand by a welding-soldering joint by using a filler, with the iron or titanium material being provided at least in the joining region with a coating preferably on the basis of zinc or aluminum before the filler is applied by forming a weld seam under melting, wherein the two sheets are joined in form of a butt-joint, with the filler on the basis of aluminum being applied for the formation of the weld seam on both sides of the sheet in a region bridging the joint onto the sheet made of the iron or titanium material in a width corresponding to at least three times the thickness of said sheet.

2. A method according to claim 1, wherein the sheet made of iron or titanium material is provided with a chamfer on at least one side of the sheet prior to the application of the coating in the region of the joint.

3. A method according to claim 1, wherein the weld seam between the two sheets as formed by the filler is flattened by plastic deformation after the application of the filler.

4. A method according to claim 1, wherein the two sheets are joined with a surface lying on one side in a common plane and, after the application of the weld seam in the region of the joint, are bent off by the respective thickness of the projecting portion of the seam over the common surface away from the same.

5. A method according to claim 1, wherein the weld seam between the two sheets as formed by the filler can be covered by a corrosion protection layer on at least one side of the sheets in the transitional region to the coated iron or titanium material, especially a coat of lacquer.

6. A method for producing a subject made of joined, cold-formed sheet blanks made of aluminum material on the one hand and or iron or titanium material on the other hand, wherein prior to a common cold forming the sheet blanks are joined by a welding-soldering joint in the form of a butt-joint by using a filler on the basis of aluminum which is applied for forming the weld seam on both sides of the sheet blank made of iron or titanium material under melting on a coating of the iron or titanium material in a width corresponding to at least three times the thickness of said sheet blank.

7. A method according to claim 6, wherein the weld seam formed by the filler between the two sheet blanks is flattened prior to the common cold forming of the joined sheet blanks.
